(19) United States
(12) Patent Application Publication
(10) Pub. No.: US 2001/0036832 A1
(43) Pub. Date: Nov. 1, 2001

(54) Emergency command and control system

(75) Inventor: Kevin Bentley McKay, Colorado Springs, CO (US)

Correspondence Address: Law Office of Dale B. Halling, LLC, 24 S. Weber Street, Suite 311, Colorado Springs, CO, 80903, US

(73) Assignee: Onscene, Inc.

(21) Appl. No.: 09/833,972

(22) Filed: Apr. 12, 2001

Related U.S. Application Data
(60) Provisional application No. 60/197,196, filed on Apr. 14, 2000.

(51) Int. Cl. H04Q 7/20

(52) U.S. Cl. 455/456; 455/457; 455/404; 455/403

(57) ABSTRACT

An emergency command and control system (30) includes a plurality of positioning subsystems (32, 34, 36). Each of the plurality of positioning subsystems (32, 34, 36) has a receiver and a transmitter and transmits positioning signal (38). A wearable tag (40) is capable of receiving the positioning signal (38) from several of the plurality of positioning systems (32, 34, 36) . The wearable tag (40) transmits a tag position. A console (42) contains a computer (44) and a receiver capable of receiving the tag position.

### FIELD OF THE INVENTION

The present invention relates generally to the field of emergency equipment and more particularly to an emergency command and control system.

### BACKGROUND OF THE INVENTION

Fires in the United States claim the lives around one hundred firefighters each year. A review of this situation by the National Fire Protection Association suggested the application of new technologies for command centers, risk management and individual firefighters. Presently firefighters wear an alarm that emits an audible sound when they have not moved within the last 30 seconds. In the confusion of a fire this audible alarm has provided very little assistance in finding down and injured firefighters. The sound is muffled by the fire and provides only the slightest clue as to the whereabouts of the downed firefighter. Other problems include the inability of the commander to have real time information on the fire as well as the location of the personnel and equipment assets.

Fire equipment and systems have failed to take advantage of the information systems most businesses use today. Fire departments' information systems are limited to 911 centers and two-way radios.

Thus there exists a need for an emergency command and control system that applies today's information technologies to fire fighting and other emergency services.

### BRIEF DESCRIPTION OF THE DRAWINGS

FIG. 1 is a cartoon drawing of emergency fire fighting situation in accordance with one embodiment of the invention;

FIG. 2 is a block diagram of an emergency command and control system in accordance with one embodiment of the invention;

FIG. 3 is a block diagram of an emergency command and control system in accordance with one embodiment of the invention;

FIG. 4 is a block diagram of a console used in an emergency command and control system in accordance with one embodiment of the invention;

FIG. 5 is a block diagram of a wearable subsystem used in an emergency command and control system in accordance with one embodiment of the invention;

FIG. 6 is schematic diagram of an emergency command and control system in accordance with one embodiment of the invention; and

FIG. 7 is a flow chart of the steps used in operating an emergency command and control center in accordance with one embodiment of the invention.

### DETAILED DESCRIPTION OF THE DRAWINGS

An emergency command and control system includes a plurality of positioning subsystems. Each of the plurality of positioning subsystems has a receiver and a transmitter and transmits a positioning signal. In one embodiment the receiver is a time modulated receiver and the transmitter uses a time modulated transmission system. A wearable tag is capable of receiving the positioning signal from several of the plurality of positioning systems. The wearable tag transmits a tag position. A console contains a computer and a receiver and a transmitter capable of receiving the tag position. This system allows the commander to track the firefighters as they move around the emergency site including their movement within building. If a firefighter requires help his exact location is known. In one embodiment, a trail of the firefighter's movements is shown on the monitor. This allows the commander to direct other firefighters through the same path used by the downed firefighter. Note that while the system is explained in conjunction with fire fighting situations it can be used by other emergency personnel and potentially has applications where ever coordination of personnel and physical assets are required or other commercial uses such as tracking children in an amusement park.

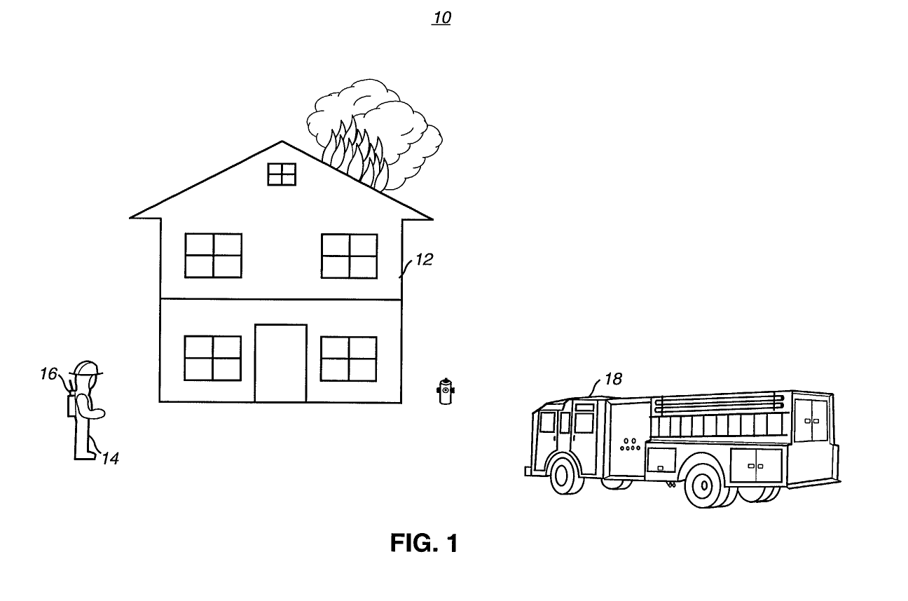

FIG. 1 is a cartoon drawing of emergency fire fighting situation 10 in accordance with one embodiment of the invention. A building 12 is on fire. The firefighter 14 has a tag 16. The fire truck 18 contains a console for tracking the position of the firefighter 14, even as the firefighter enters the building. The fire truck 18 may also have a positioning subsystem.

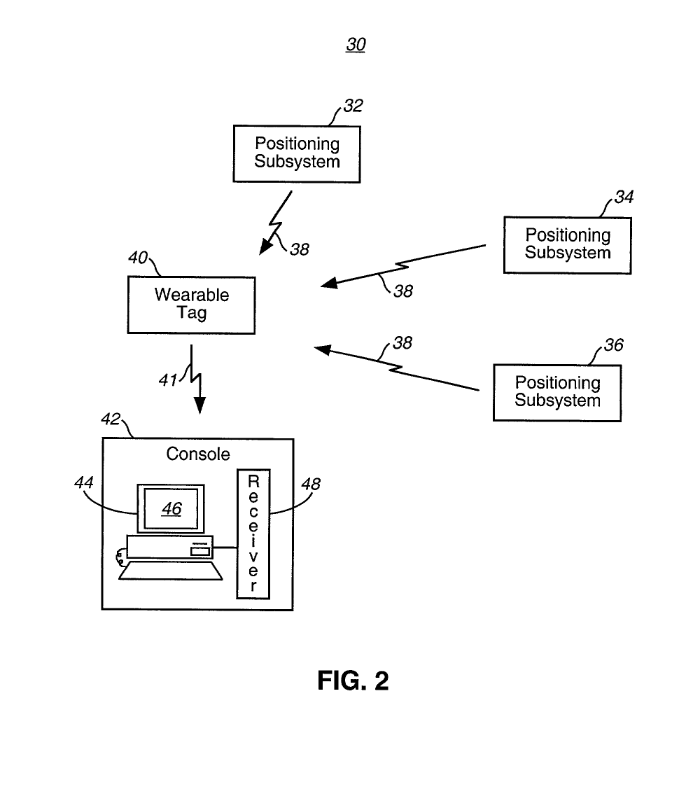

FIG. 2 is a block diagram of an emergency command and control system 30 in accordance with one embodiment of the invention. The system 30 includes a plurality of positioning subsystems 32, 34, 36. The plurality of positioning subsystems transmit a positioning signal 38 to a wearable tag 40. The wearable tag 40 receives the positioning signals 38. The wearable tag 40 then calculates its position in one embodiment. The wearable tag 40 then transmits a tag position 41 to the console 42. In another embodiment, the wearable tag 40 transmits information about the positioning signals 38 to the console 42. The console 42 then calculates the wearable tag position. The console 42 includes a computer 44, with a monitor 46 and receiver 48. Note that the tag's position can be calculated using a variety of methods. For instance, a broad bandwidth signal can be transmitted from each of the plurality of positioning subsystems 32, 34, 38. The tag 40 then performs a triangulation based on these signals. Note it may require four positioning subsystems to unambiguously define the tags position in three dimensional space. In addition, the location of the positioning systems must be known either absolutely or relative to a spot such as the console 42. If an absolute position is selected, a GPS receiver may be incorporated into the positioning subsystems 32, 34, 46 and perhaps the console 42.

In another embodiment, the location system uses a wide bandwidth signal in combination with a steerable antenna. The time delay provides the distance between the tag and a positioning system and the steerable antenna provides the direction of the tag. Presently the preferred system for determining the position of the tag uses equipment developed by Time Domain Corporation of Huntsville Ala. This technology is a wide bandwidth impulse technology. For more information on this technology see U.S. Pat. No. 6,133,876. The wide bandwidth provides excellent penetration of buildings and structures. The pulse nature of the technology is well suited to determining distances based on time delays. When the technology is combined with steerable antennas, such as phased array antennas, the position of firefighters can be accurately determined at emergency sites.

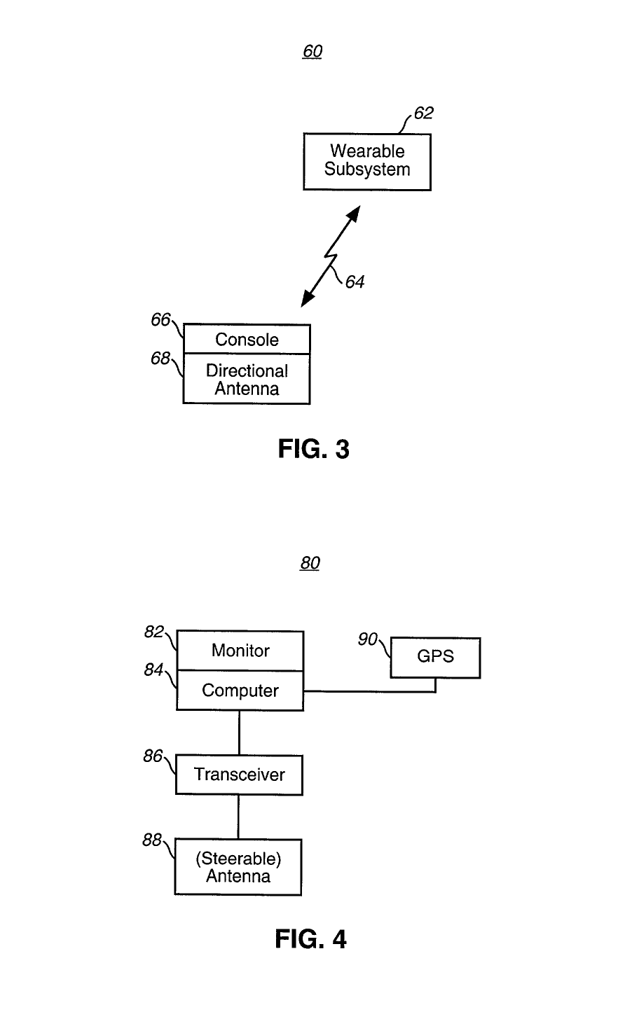

FIG. 3 is a block diagram of an emergency command and control system 60 in accordance with one embodiment of the invention. The system 60 includes a wearable subsystem 62 that transmits and receives a positioning signal 64. A console 66 receives and transmits the positioning signal 64. The console 66 includes a directional antenna 68. The console 66 uses the positioning signal and the direction of the directional antenna 68 to calculate the position of the wearable subsystem 62. The position of the wearable subsystem 62 is displayed on the console 66. In one embodiment, the console 66 has an impulse radio transmitter (transceiver). The impulse transmitter (transceiver) may be similar to the impulse radio system manufactured by Time Domain Corporation of Huntsville, Alabama. The wearable subsystem may also have an impulse radio transmitter (transceiver). In one embodiment, the wearable subsystem transmits an alarm when the wearable subsystem has not moved for a predetermined period of time. The alarm may be sent over the radio channel or it may be an audible alarm. Note that the wearable subsystem may have a directional antenna, such as a phased array antenna. In one embodiment, the console includes a GPS receiver.

FIG. 4 is a block diagram of a console 80 used in an emergency command and control system in accordance with one embodiment of the invention. The console 80 includes a monitor 82 and a computer 84. In one embodiment, the monitor displays a trace of all the positions the firefighter has been since arriving at the emergency site. The computer 84 is connected to a transceiver 86. The transceiver 86 may be an impulse radio. The transceiver 86 may be used to determine the position of the firefighters. In addition, the transceiver 86 may send and receive data and voice information. The data can include vitals signs of a firefighter, information gathered by other firefighters about the fire or directions to a injured fellow firefighter. In the preferred embodiment, the same transceiver will be used for both, position, voice and data information. However, the invention is not limited to a single transmitter (transceiver) solution. An antenna 88 is connected to the transceiver 86. In one embodiment, the antenna is steerable. In one embodiment, the console 80 includes a GPS receiver 90.

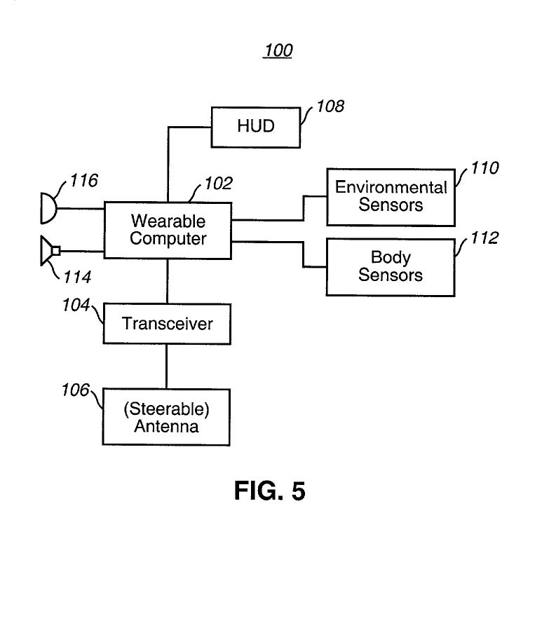

FIG. 5 is a block diagram of a wearable subsystem 100 used in an emergency command and control system in accordance with one embodiment of the invention. The wearable subsystem 100 includes a wearable computer 102 in one embodiment. The wearable computer 102 is connected to a transceiver 104. The transceiver 104 is connected to an antenna 106 that may be steerable. The wearable computer 102 is connected to a heads-up display (HUD) 108. The HUD 108 can display all sorts of data for the firefighter. For instances, the HUD 108 can display, the location of other firefighters, the firefighters vital signs or messages from the commander. The computer 102 is also connected to various environmental sensors 110. These sensors may include temperature sensors, infrared sensors, oxygen or other gas levels. The computer 102 is also connected to various body sensors 112. These body sensors 112 may be taped to the firefighter's body or may be placed in equipment that is contact with the firefighter's body. For instance, body sensors may be affixed to a headband of a firefighter's helmet. A speaker 114 and microphone 116 are connected to the computer 102 to facilitate voice communications. A wearable subsystem may contain some subset of these features. For instance, one version of the wearable subsystem might just include the transceiver, antenna and associated microprocessor. The microprocessor might calculate the position of the firefighter, although this task might be performed at the console. This scaled down system's main function is to determine the location of the firefighter.

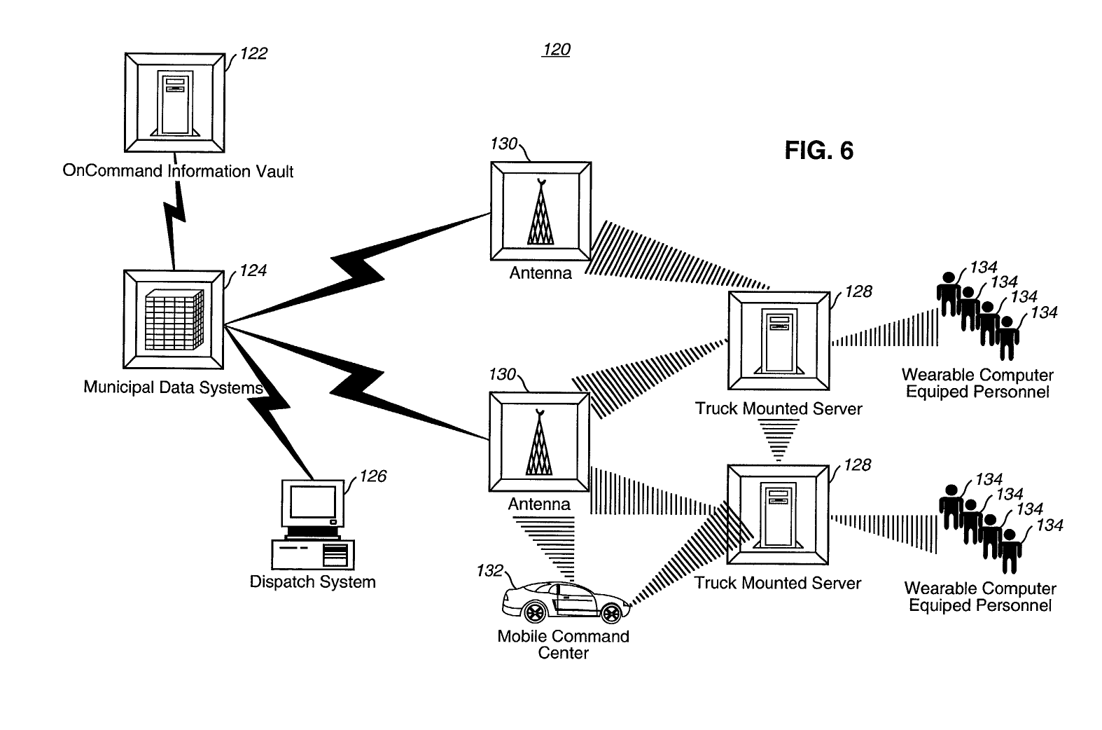

FIG. 6 is schematic diagram of an emergency command and control system 120 in accordance with one embodiment of the invention. The emergency command and control system 120 includes an information vault 122. The information vault 122 stores all data, including security, mapping data, individual medical histories, and provides access to existing municipal data sources 124 via connector objects. All system wide business rules are stored on this server as well as the logic necessary to execute the business rules. Data access is provided through industry standard mechanisms such as Java Data Base Connectivity (JDBC), ensuring database independence. Communication from the Information Vault to any other platform will also be industry standards such as, Remote Method Invocation (RMI) and Internet Interoperability Protocol (IIOP). The information vault 122 is connected to a dispatch system 126. The dispatch console 126 provides all the current dispatch functions plus the ability to track all mobile assets. The municipal data systems 124 are connected to the truck mounted servers 128 by ground based antennas 130. These antennas are situated around a municipality and effectively tie the mobile based computing into the existing municipal data network. In most cases the existing towers that serve the 800 Mhz communications system are reused. These antennas may also be used for triangulation purposes. The truck mounted servers 128 are located on fire trucks or command vehicles. The servers 128 track, monitor and provide feedback to personnel under its command. These servers also have the capability to communicate with other mobile servers, which provides fault tolerance and expands the command structure. The server receives location data from the wearable computers (tags) and this information is relayed to others in the same tactical situation. The mobile servers also provide access to digital video stored on the information vault. The digital video is a annotated video of the building or structure. It provides a layout of the structure as well as pertinent information. For instance, it might state that a child normally sleeps in this room or flammable chemicals are stored in the room. A mobile command center 132 is in communication with the servers 128. The mobile command center 132 includes a command console. The console allows the chief and staff to monitor and control large scale situations. The servers 128 communicate with the wearable computers 134. The wearable computers are equipped with a heads up display, which shows 3D views of the current engagements. The features of the computer are voice activated. Video and thermal imaging cameras may be attached to the computer. Personal vital sign monitoring devices are connected to the wearable computer. The vital signs can be compared to previously stored vital signs that are stored in the information vault 122. This provides an early warning that a firefighter is approaching his limits. When these devices are not in a tactical situation, they can perform the functions of a normal office computer.

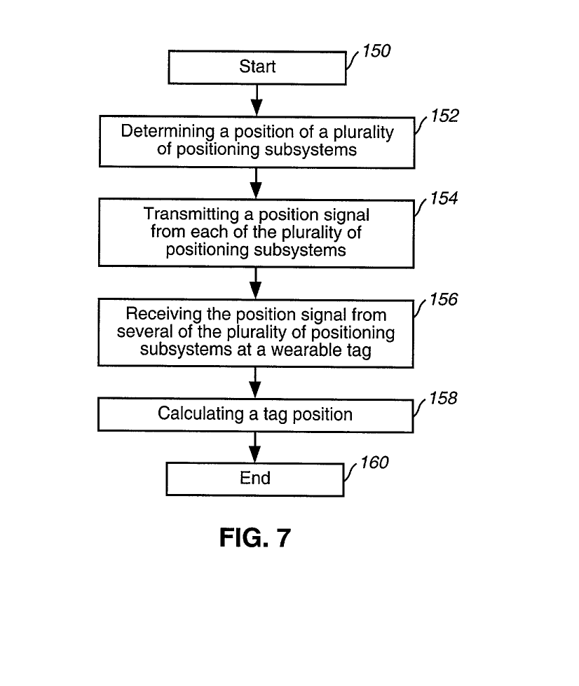

FIG. 7 is a flow chart of the steps used in operating an emergency command and control center in accordance with one embodiment of the invention. The process starts, step 150, by determining a position of a plurality of positioning systems at step 152. A position signal is transmitted form each of the plurality of positioning systems at step 154. The position signal is received from several of the plurality of positioning subsystems at a wearable tag at step 156. At step 158 a tag position is calculated which ends the process at step 160. In one embodiment the tag position is displayed on a monitor of the console. When the tag position has remained stationary for a predetermined period of time, an alert is transmitted to the console. An audible alarm (audible alert) may also be emitted by the tag. In one embodiment, the fire fighter is displayed as an icon on the monitor and the icon flashes when an associated tag has issued an alert. In one embodiment, the position signal is transmitted using a time modulated ultra wide band multiple access transmission system.

Thus there has been described an emergency command and control system that can determine the position of firefighter essentially continuously while at an emergency site. In addition, the system integrates many of the available information technologies for the purpose of handling emergence situations.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An emergency command and control system, comprising:
a plurality of positioning subsystems, each of the plurality of positioning subsystems having a receiver and a transmitter, the plurality of positioning subsystems transmitting a positioning signal;
a wearable tag capable of receiving the positioning signal from several of the plurality of positioning systems, the wearable tag transmitting a tag position; and
a console containing a computer and a receiver capable of receiving the tag position.

2. The system of claim 1, wherein each of the plurality of positioning subsystems has a time modulated receiver.

3. The system of claim 1, wherein the transmitter in each of the plurality of positioning subsystems uses a time modulated transmission system.

4. The system of claim 1, wherein the wearable tag transmits an alert when the wearable tag has been stationary for a predetermined period of time.

5. The system of claim 1, wherein the alert is an audible alert.

6. The system of claim 1, wherein the wearable tag monitors a user's vital signs.

7. The system of claim 1, wherein the console includes a time modulated receiver.

8. The system of claim 1, wherein the console displays a location of the wearable tag.

9. The system of claim 8, wherein an icon representing the wearable tag flashes when the console receives an alert from the wearable tag.

10. A method of operating an emergency command and control system, comprising the steps of:
a) determining a position of a plurality of positioning subsystems;
b) transmitting a position signal from each of the plurality of positioning subsystems;
c) receiving the position signal from several of the plurality of positioning subsystems at a wearable tag; and
d) calculating a tag position.

11. The method of claim 10, further including the step of:
e) displaying the tag position on a monitor of the console.

12. The method of claim 11, further including the step of:
f) when the tag position has remained stationary for a predetermined period of time, transmitting an alert to the console.

13. The method of claim 12, further including the step of:
g) emitting an audible alarm.

14. The method of claim 10, wherein step (b) further includes the step of:
b1) transmitting the position signal using a time modulated ultra wide band multiple access transmission system.

15. An emergency command and control system, comprising:
a wearable subsystem transmitting and receiving a positioning signal; and
a console, having a directional antenna, transmitting and receiving the positioning signal and calculating a wearable subsystem position, the console displaying the wearable subsystem position on a display.

16. The system of claim 15, wherein the console has an impulse radio transmitter.

17. The system of claim 15, wherein the wearable subsystem has an impulse radio transmitter.

18. The system of claim 15, wherein the wearable subsystem transmits an alarm when the wearable subsystem has not moved for a predetermined period of time.

19. The system of claim 15, wherein the wearable subsystem has a directional antenna.

20. The system of claim 15, further including a GPS receiver connected to the console.
